(19) United States
(12) Patent Application Publication
(10) Pub. No.: US 2026/0270076 A1
(43) Pub. Date: Sep. 10, 2026

(54) SYSTEM AND METHOD OF AUTHENTICATION BETWEEN ELECTRONIC CONTROL UNITS (ECUs) ON A TRANSPORTATION VEHICLE NETWORK

(71) Applicant: International Engine Intellectual Property Company, LLC, Lisle, IL (US)

(72) Inventor: Krishna Teja Medam, Naperville, IL (US)

(73) Assignee: International Engine Intellectual Property Company, LLC, Lisle, IL (US)

(21) Appl. No.: 19/069,462

(22) Filed: Mar. 4, 2025

(51) Int. Cl. G06F 21/44

(52) U.S. Cl. CPC H04L 9/3242; G06F 21/44

(57) ABSTRACT

An electronic control unit (ECU) device is disclosed. The ECU device is connected to an on-vehicle network inside a vehicle includes a communication interface configured to communicate via the on-vehicle network to a gateway ECU to authenticate the ECU device; at least one processor; and a memory storing at least one computer instruction executable by the at least one processor to: a) generate a n-bit hash based at least in part on a first message and a key, wherein the first message is based at least in part on a skipping counter with a rollover strategy; b) extract a j-bit hash out of the n-bit hash, where j is an integer less than n; and c) cause the communication interface to send the j-bit hash via the on-vehicle network to the gateway ECU to authenticate the ECU device.

### FIELD OF THE DISCLOSURE

The present disclosure relates generally to vehicle security, and more particularly to security of electronic control units (ECUs).

### BACKGROUND

In recent years, the automotive industry has witnessed a significant increase in cyberattacks targeting components within transportation vehicle networks. These attacks pose substantial risks, including unauthorized manipulation or replacement of components, which can lead to safety hazards, operational discontinuity, privacy, and financial losses. Many legacy vehicles are equipped with systems/ECUs that have limited computational power and minimal flash memory. Traditional security measures often rely on robust security mechanisms/controls that are not feasible for these older systems due to their resource constraints, making those legacy systems particularly vulnerable to such threats.

Existing solutions for authentication typically involve complex protocols that require significant processing power and memory, which are not available in legacy systems. This creates a pressing need for a security solution that can effectively authenticate components without overburdening their limited resources. The challenge is to develop a method that ensures authenticity while preventing spoofing and replay attacks, all within the constraints of legacy vehicle architectures. Addressing these challenges is important for enhancing the security and reliability of vehicle networks in the face of evolving cyber threats.

Therefore, a need exists for an improved authentication system and method.

### SUMMARY

One advantage of the described system lies in its approach to enhancing the security of electronic control units (ECUs) within a transportation vehicle network by implementing a lightweight cryptographic authentication mechanism. This system continuously verifies the authenticity of leaf ECUs by a central gateway ECU using any lightweight cryptographic algorithms such as HMAC-SHA256, which can fit into the devices with limited computational power. The system introduces a method of using a skipping counter with a rollover strategy, as an example, to generate a hash, which is then truncated to fit the constraints of legacy on-vehicle network systems, such as controller area network (CAN) bus systems. This approach not only ensures the authenticity of ECUs but also mitigates the risk of replay attacks by introducing randomness and unpredictability in the authentication process, thereby providing a robust solution for legacy vehicles vulnerable to cyberattacks.

Some embodiments include one or more of the following features:
1. Lightweight Cryptographic Authentication for ECUs: The use of lightweight cryptographic algorithms specifically tailored for ECUs with limited computational power is a novel approach. This development addresses the challenge of authenticating ECUs in legacy vehicles, which have minimal flash memory and computational capabilities. The approach includes the adaptation of cryptographic algorithms such as SHA-2/3, RIPEMD, HMAC SHA256/512, Whirlpool, OMAC, CMAC and PMAC to create a hash or message authentication code (MAC) of the input, which is then used for continuous verification of leaf ECUs by a central gateway ECU. This method provides a practical solution for maintaining the authenticity of ECUs, preventing spoofing and replay attacks, and ensuring vehicle safety and security.
2. Use of Rolling and Skipping Counters in Cryptographic Verification: The introduction of rolling and skipping counters as inputs to the cryptographic algorithm is a feature. This approach adds randomness and complexity, making it difficult for attackers to perform replay attacks. The approach includes the use of a skipping counter that can be synchronized based on date/time or a pre-made list of random numbers, which enhances security by altering the rolling counter series.
3. Truncated Hash Extraction for ECU Authentication: The method of extracting a j-bit hash from an n-bit hash for transmission over the on-vehicle network (e.g., CAN) bus is a novel approach to reduce data size while maintaining security. The method involves selecting a pre-agreed size and location for extracting and truncating the n-bit hash, which adds flexibility and security to the authentication process.
4. Creative Variations in Cryptographic Implementation: The described system enables creative variations in the implementation of cryptographic algorithms, such as mixing different hashing or MAC algorithms, range of rolling counter, hash/MAC length and appending custom information to the rolling counter. The system provides flexibility to tailor the cryptographic process based on the microcontroller's capability and the criticality of the application, which enhances security and adaptability. This flexibility allows for scalable and customizable security solutions for different vehicle architectures and requirements.

In one embodiment, the disclosure includes an electronic control unit (ECU) device connected to an on-vehicle network inside a vehicle, comprising a communication interface configured to communicate via the on-vehicle network to a gateway ECU to authenticate the ECU device; at least one processor; and a memory storing at least one computer instruction executable by the at least one processor to generate a n-bit hash based at least in part on a first message and a cryptographic element, wherein the first message is based at least in part on a skipping counter with a rollover strategy; extract a j-bit hash out of the n-bit hash, where j is an integer less than n; and cause the communication interface to send the j-bit hash via the on-vehicle network to the gateway ECU to authenticate the ECU device.

In another embodiment, the ECU device is configured to, periodically, at predetermined intervals, increment the skipping counter by i, where i is an integer greater than 1, and repeat the generation, extraction, and sending of the hash to continually authenticate the ECU device to the gateway ECU. If the skipping counter reaches a reset value associated with the rollover strategy, the processor is configured to split i into a first value corresponding to a maximum limit of the skipping counter and a remainder value and roll over the skipping counter to restart at the remainder value.

In a further embodiment, the j-bit hash is an integer based on a legacy on-vehicle network bus size, and the hash function used to generate the n-bit hash is based on a legacy ECU random access memory (RAM) size. The processor is configured to extract the j-bit hash by truncating a plurality of bits of the n-bit hash, where the number and location of the bits to be truncated are predetermined by the ECU gateway and the ECU device and not communicated via the on-board network.

In yet another embodiment, the gateway ECU device is connected to an external network outside the vehicle, and a failure of any ECU device connected to the on-board network to authenticate is communicated to the external network. The processor is also configured to generate the n-bit hash using a plurality of different hash functions with the first message and a specific input as components.

In an additional embodiment, the disclosure includes an ECU device connected to an on-vehicle network inside a vehicle, comprising a communication interface configured to communicate via the on-vehicle network to a leaf ECU device to authenticate the leaf ECU device; at least one processor; and a memory storing at least one computer instruction executable by the at least one processor to generate a n-bit hash based at least in part on a first message and a cryptographic element, wherein the first message is based at least in part on a skipping counter with a rollover strategy; extract a first j-bit hash out of the n-bit hash, where j is an integer less than n; and cause the communication interface to receive a second j-bit hash via the on-vehicle network from the leaf ECU device and compare the second j-bit hash to the first j-bit hash to authenticate the leaf ECU device.

In another embodiment, the ECU device is configured to, periodically, at predetermined intervals, increment the skipping counter by i, where i is an integer greater than 1, and repeat the generation, extraction, and comparison of the hash to continually authenticate the leaf ECU device. If the skipping counter reaches a reset value associated with the rollover strategy, the processor is configured to split i into a first value corresponding to a maximum limit of the skipping counter and a remainder value and roll over the skipping counter to restart at the remainder value.

In a further embodiment, the j-bit hash is an integer based on a legacy on-vehicle network bus size, and the hash function used to generate the n-bit hash is based on a legacy ECU random access memory (RAM) size. The processor is configured to extract the j-bit hash by truncating a plurality of bits of the n-bit hash, where the number and location of the bits to be truncated are predetermined by the ECU device and the leaf ECU device and not communicated via the on-board network.

In yet another embodiment, the ECU device is connected to an external network outside the vehicle, and a failure of any leaf ECU devices connected to the on-board network to authenticate is communicated by the ECU device to the external network. The processor is also configured to generate the n-bit hash using a plurality of different hash functions with the first message and an input as components.

In an additional embodiment, the disclosure includes a method implemented by an ECU device connected to an on-vehicle network inside a vehicle, comprising a communication interface configured to communicate via the on-vehicle network to a gateway ECU to authenticate the ECU device; at least one processor; and a memory storing at least one computer instruction executable by the at least one processor to generate a n-bit hash based at least in part on a first message and a cryptographic element, wherein the first message is based at least in part on a skipping counter with a rollover strategy; extract a j-bit hash out of the n-bit hash, where j is an integer less than n; and cause the communication interface to send the j-bit hash via the on-vehicle network to the gateway ECU to authenticate the ECU device.

In another embodiment, the method further comprises, periodically, at predetermined intervals, incrementing the skipping counter by i, where i is an integer greater than 1, and repeating the generation, extraction, and sending of the hash to continually authenticate the ECU device to the gateway ECU. If the skipping counter reaches a reset value associated with the rollover strategy, the method comprises splitting i into a first value corresponding to a maximum limit of the skipping counter and a remainder value and rolling over the skipping counter to restart at the remainder value.

In a further embodiment, the j-bit hash is an integer based on a legacy on-vehicle network bus size, and the hash function used to generate the n-bit hash is based on a legacy ECU random access memory (RAM) size. The method of extracting the j-bit hash out of the n-bit hash comprises truncating a plurality of bits of the n-bit hash, where the number and location of the bits to be truncated are predetermined by the ECU gateway and the ECU device and not communicated via the on-board network.

In yet another embodiment, the method of generating the n-bit hash comprises using a plurality of different hash functions with the first message and the input as inputs. These and other features will be more clearly understood from the following detailed description taken in conjunction with the accompanying drawings and claims.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope.

FIG. 1 is a schematic diagram illustrating the network of ECUs within a vehicle, highlighting the communication between the GW ECU and leaf ECUs, in accordance with a representative embodiment of the present disclosure.

FIG. 2 is a system diagram illustrating the continuous authentication process between a leaf ECU and a gateway ECU over an on-vehicle network (OVN) bus using a 64-bit hash, in accordance with a representative embodiment of the present disclosure.

FIG. 3 illustrates a block diagram of the process for generating and transmitting a truncated HMAC hash over an OVN bus, in accordance with a representative embodiment of the present disclosure.

FIG. 4 is a schematic flow chart diagram illustrating the process of generating and verifying a truncated 64-bit hash for ECU authentication over an OVN bus, in accordance with a representative embodiment of the present disclosure.

FIG. 5 illustrates a message flow diagram depicting the communication between a Leaf ECU and a Gateway ECU over an OVN Bus, in accordance with a representative embodiment of the present disclosure.

FIG. 6 illustrates a diagram of truncated hash extraction for ECU authentication, in accordance with a representative embodiment of the present disclosure.

FIG. 7 is a block diagram illustrating the communication and processing components of the Leaf ECU Device and Gateway ECU Device, in accordance with a representative embodiment of the present disclosure.

FIG. 8 illustrates a flow chart diagram of the process for generating, extracting, and sending a hash for ECU authentication, in accordance with a representative embodiment of the present disclosure.

FIG. 9 illustrates a flow chart diagram of the process for generating, extracting, and comparing hashes for ECU authentication, in accordance with a representative embodiment of the present disclosure.

In the following detailed description, various embodiments are described with reference to the appended drawings. Those of ordinary skill in the art will appreciate that the drawings are illustrated for simplicity and clarity and therefore may not be drawn to scale and may not include well-known features, that the order of occurrence of actions or steps may be different than the order described or may be performed concurrently unless specified otherwise, and that the terms and expressions used herein have the meaning understood by those of ordinary skill in the art except where different meanings are attributed to them herein. Like reference numerals refer to like elements or components throughout. Like elements or components will therefore not necessarily be described in detail with respect to each figure.

### DETAILED DESCRIPTION

The present disclosure relates to security of ECUs within a transportation vehicle network. Some embodiments of the described technology address the increasing threat of cyberattacks on transportation vehicle networks, specifically targeting electronic control units (ECUs). The problem arises from the ease of manipulating or replacing ECUs, which can lead to safety risks, operational discontinuity, privacy, and financial losses. Legacy vehicles with ECUs lacking computational power are particularly vulnerable due to their inability to implement strong cryptographic authentication mechanisms. The proposed solution involves a lightweight cryptographic methodology for continuous verification of leaf ECUs by a central or gateway ECU. This method employs cryptographic algorithms like SHA-2/3, RIPEMD, HMAC SHA256/512, Whirlpool, OMAC and PMAC to generate a hash or MAC of the input, which is based on factors such as rolling counters and hash/MAC size. In some embodiments, the digest is 256 bits long, but a pre-agreed size and location can be used to trim it for verification. The described technology aims to prevent spoofing and replay attacks by introducing varied inputs that complicate reverse engineering. The solution is not a replacement for SecOC but complements it by focusing on ECU-to-ECU authentication whereas SecOC focuses on individual message authentication.

Some embodiments of the present disclosure outline a cryptographic solution for continuous ECU-to-ECU authentication within a transportation vehicle network. The system alerts the gateway ECU if authentication fails, aiming to maintain authenticity and prevent spoofing and replay attacks. The solution is lightweight, designed for legacy systems with minimal flash memory and limited computational power. It involves hashing and/or MAC algorithms, using data such as rolling counters and skipping counters to create randomness and avoid replay attacks. One representative implementation includes a 64-bit hash transmitted over the CAN bus, with verification performed by the gateway ECU. This approach allows for creative variations, such as truncating hashes and mixing algorithms, to enhance security. The solution is scalable and can be integrated into intrusion detection systems, providing a lightweight and adaptable approach to ECU authentication and detect intruders.

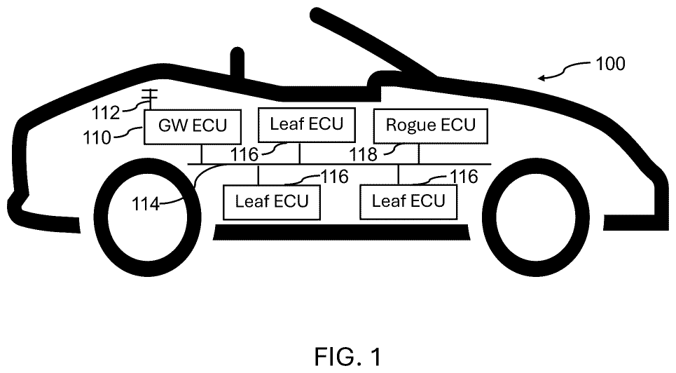

FIG. 1 shows a vehicle 100 equipped with a network of electronic control units (ECUs) designed to enhance security through a novel authentication mechanism. The central component of this network is the gateway ECU 110, which serves as the primary node responsible for managing and verifying the authenticity of other ECUs within the vehicle. The gateway ECU 110 is connected to a wireless network interface 112, enabling communication with external networks for reporting purposes. In alternative embodiments, the gateway ECU may be connected to a telematics unit, which has a wireless network interface. In such embodiment, the gateway ECU and telematics unit may communicate through an on-vehicle network.

The vehicle network includes multiple leaf ECUs 116, which are distributed throughout the vehicle 100. These leaf ECUs 116 are responsible for various functions and are required to periodically authenticate themselves to the gateway ECU 110. This authentication process plays a significant role in maintaining the integrity and security of the vehicle's electronic systems, ensuring that only authorized ECUs are operational.

An on-vehicle network (e.g., controller area network (CAN)) bus 114 facilitates communication between the gateway ECU 110 and the leaf ECUs 116. The OVN bus 114 is a robust and efficient communication protocol commonly used in automotive applications, allowing for the seamless exchange of data between ECUs. In some embodiments, the OVN is a CAN. In other embodiments, the OVN is another type of on-vehicle network.

Additionally, FIG. 1 illustrates a rogue ECU 118, which represents a potential security threat. The rogue ECU 118 is unable to authenticate itself to the gateway ECU 110, highlighting the system's ability to detect unauthorized or compromised ECUs. Upon detecting such an authentication failure, the gateway ECU 110 can report the incident to an external network via the wireless communication interface 112, enabling timely intervention and mitigation of potential security risks.

This configuration underscores the significance of the technological advancement in providing a lightweight and effective cryptographic authentication mechanism for ECUs, particularly in legacy vehicles with limited computational resources. The system's ability to detect and report unauthorized ECUs enhances the overall security and reliability of the vehicle network.

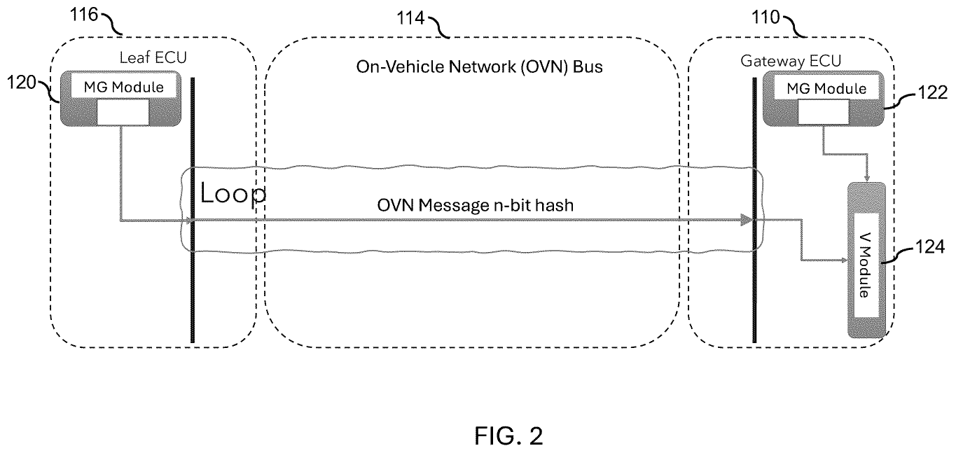

FIG. 2 shows a representative continuous authentication process between a leaf ECU 116 and a gateway ECU 110 over an on-vehicle network (OVN) bus 114. This figure illustrates the modules involved in the authentication process, highlighting the use of cryptographic mechanisms to ensure secure communication between the ECUs. In some embodiments, the OVN bus is a CAN bus. In other embodiments, the OVN bus may be other types of on-vehicle network communication systems and protocols.

The leaf ECU 116 is equipped with a message generator (MG) module 120 that generates an n-bit hash, e.g., 64-bit hash. This hash is a result of a process that involves inputs such as a skipping counter and a key. The generated hash is then transmitted over the OVN bus 114 as a OVN message. The loop depicted in the figure indicates the periodic nature of this authentication process, where the leaf ECU 116 continuously and periodically generates and sends the hash to the gateway ECU 110. The n can be any positive integer, greater than or less than 64.

The OVN bus 114 serves as the communication medium between the leaf ECU 116 and the gateway ECU 110. This facilitates the transmission of the hash, ensuring that the data is efficiently communicated between the ECUs within the vehicle network.

On the gateway ECU 110, a message generator (MG) module 122 similar to that on the leaf ECU 116 is used to generate an expected hash based on the same inputs. This ensures that both ECUs are synchronized in their cryptographic processes. The gateway ECU 110 also includes a verification module 124, which compares the received hash from the leaf ECU 116 with the expected hash generated by the message generator module 122. If the hashes match, the leaf ECU 116 is authenticated successfully. If there is a discrepancy, the verification module 124 triggers a response to handle the potential security threat, such as alerting the system and/or isolating the compromised ECU.

The modules described herein, including the message generator modules 120 and 122, as well as the verification module 124, may be implemented in various forms. These modules can be realized through computer hardware, computer software, or a combination of both, such as firmware.

When implemented in hardware, the modules may consist of dedicated electronic circuits or components designed to perform specific functions related to cryptographic processing and verification. This could include the use of microcontrollers, application-specific integrated circuits (ASICs), or field-programmable gate arrays (FPGAs) that are configured to execute the necessary operations.

Alternatively, when implemented in software, the modules may comprise program code or instructions stored in a computer-readable medium, which are executed by a processor within the ECU. This software-based approach allows for flexibility in updating and modifying the cryptographic processes as needed.

In some cases, a combination of hardware and software, known as firmware, may be used to implement the modules. Firmware provides a balance between the performance benefits of hardware and the adaptability of software, enabling efficient execution of cryptographic functions while allowing for updates and enhancements.

This flexibility in implementation ensures that the system can be tailored to meet the specific requirements and constraints of different vehicle architectures, particularly those of legacy systems with limited computational resources.

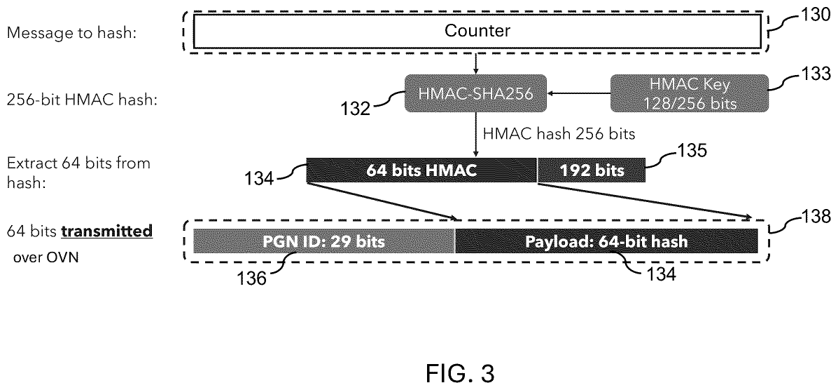

FIG. 3 illustrates a detailed process implemented by a leaf ECU to generate a hash and format a message for communication over the OVN bus to a gateway. This process is an example of the method that may be implemented by the MG module 120. The figure illustrates the use of a counter 130, which serves as the message to hash. This counter is part of a skipping counter with a rollover strategy, providing the basis for generating a cryptographic hash.

A pure rolling counter is prone to replay attacks. Skipping counters can create randomness and are thus preferred. The skipping counter can be synced based on date and/or time or a pre-made list of random numbers, as examples. With a constant skipping number, after reaching a maximum limit for the counter, the counter resets and the same numbers in the series are generally repeated. This can also allow for replay attacks. Thus, in some embodiments, at a maximum limit the skipping number can be split so that the exact maximum number for the counter can be reached, and the remainder of the skipping number split can be used at the beginning of the next rollover. This changes the rolling counter series.

### EXAMPLE

Range of Rolling Counter: 1 to 500. Skipping Number: 7.
Closest multiplier of 7 to 500 is 497. Thus, 7 is split into 3 and 4 to reach 500. After rollover, the counter starts from 4 (instead of 1). Thus, the entire rolling counter series changes.

The hash generation process begins with the hash function 132, which utilizes the counter 130 and a key 133 as inputs to produce a hash, e.g., 256-bit HMAC hash. The hash function 132 is a lightweight cryptographic function suitable for devices with limited computational resources, such as those found in legacy vehicle systems.

Once the 256-bit HMAC hash is generated, a 64-bit portion 134 is extracted from the hash and the remaining 192-bit portion 135 is truncated or dropped. This extraction process involves selecting a specific segment of the hash, which is predetermined and agreed upon by the ECU and the gateway ECU. The extracted 64-bit hash 134 serves as the payload for the message to be transmitted over the OVN bus.

The message 138 prepared for transmission includes a parameter group number (PGN) identifier 136, which is 29 bits in length. The PGN ID 136 is used in the J1939 protocol to categorize and differentiate various types of data messages on the OVN bus. The inclusion of the PGN ID 136 in the message 138 indicates to the gateway ECU that the transmitted message contains an authentication data payload.

The payload 134, consisting of the 64-bit hash, is then transmitted over the OVN bus as part of the message 138. This process ensures that the leaf ECU can authenticate itself to the gateway ECU, maintaining the integrity and security of the vehicle's electronic systems. The use of a 64-bit hash allows for efficient data transmission while preserving the authenticity of the communication between the ECUs.

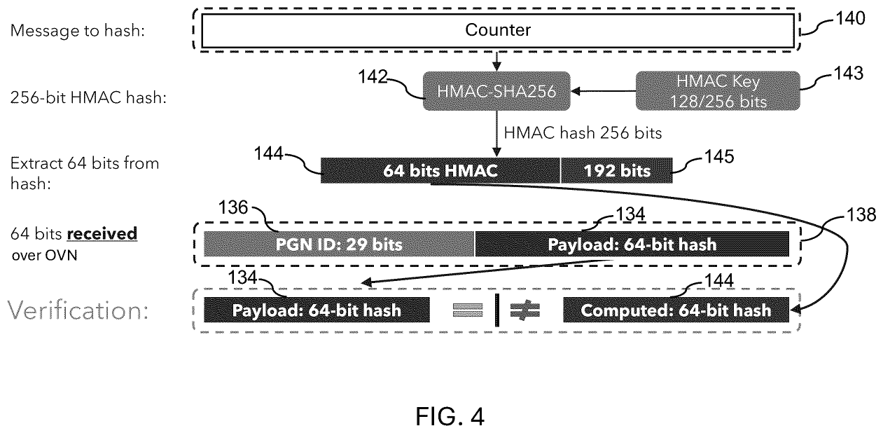

Although FIGS. 3 and 4 show a representative hash function, having a specific bit size (256) and an extraction of a specific number of bits (64) and/or truncation of a specific number of bits (192), it is for illustrative purposes and alternative embodiments are contemplated, such as, for example, other lightweight hash functions and bit-lengths. This representative method generally starts with a message to hash which is a skipping counter with a rollover strategy and then proceeds to the following steps:
a) generate a n-bit hash based at least in part on the message to hash and a key, wherein the message is based at least in part on the skipping counter with the rollover strategy;
b) extract a j-bit hash out of the n-bit hash, where j is an integer less than n;
c) cause the communication interface to send the j-bit hash via the on-vehicle network to the gateway ECU to authenticate the ECU device; and
d) periodically, at predetermined intervals:
   increment the skipping counter by i, where i is an integer greater than 1; and
   repeat a), b) and c) to continually authenticate the ECU device to the gateway ECU.

In FIGS. 3 and 4, n=256 and j=64, but in other embodiments, n and j can be other integer numbers, where j is an integer less than n. This flexibility allows for adaptation to different cryptographic requirements and constraints.

FIG. 4 illustrates a process similar to that shown in FIG. 3, but implemented by a gateway ECU, such as through the MG module 122 and verification module 124 as depicted in FIG. 2. This process involves computing the expected payload 144 and comparing it to the received payload 134 to authenticate a leaf ECU.

The process begins with a counter 140, which serves as the message to hash, i.e., an input to the hash function 142. This counter is part of a skipping counter with a rollover strategy (as described above with reference to FIG. 3), providing the basis for generating a hash. The hash generation is performed using the hash function 142, which utilizes a key 143 of either 128 or 256 bits to produce a 256-bit HMAC hash. This hash is derived from the message to hash, which is based on the counter 140.

Once the 256-bit HMAC hash is generated, a 64-bit portion 144 is extracted from the hash. This extraction process involves selecting a specific segment of the hash, which is predetermined and agreed upon by the ECU and the gateway ECU. The extracted 64-bit hash 144 serves as the expected payload for the message to be received over the OVN bus.

The message 138 received includes a parameter group number (PGN) identifier 136, which is 29 bits in length. The PGN ID 136 is used in the J1939 protocol to categorize and differentiate various types of data messages on the OVN bus. The inclusion of the PGN ID 136 in the message 138 indicates to the gateway ECU that the received message contains an authentication data payload.

The verification process involves comparing the received payload 134, which should be a 64-bit hash received over the OVN bus, with the computed 64-bit hash 144. If the received payload 134 matches the expected payload 144, the leaf ECU is successfully authenticated. If there is a discrepancy, the gateway ECU reports the failure of the leaf ECU to authenticate to an external network, such as the vehicle security operations center (VSOC), thereby enabling timely intervention and mitigation of potential security risks. A failure can also result from the leaf ECU failing to send the authentication message at the expected frequency, which can indicate that the leaf ECU is a rogue ECU.

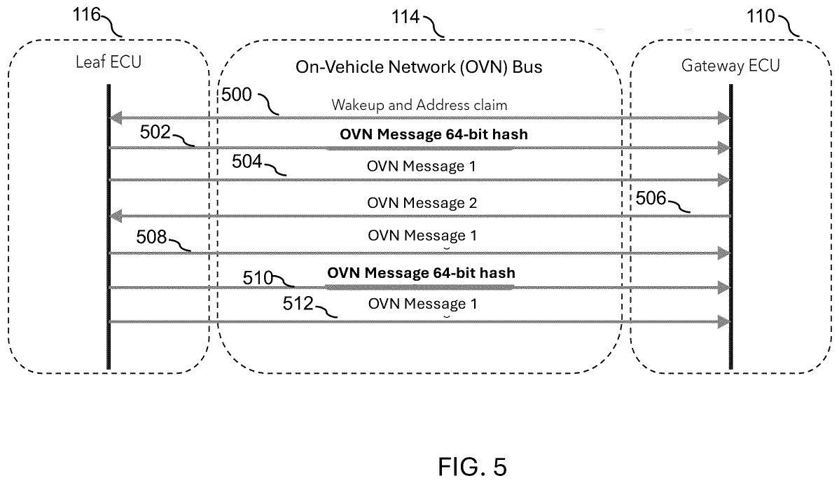

FIG. 5 shows a representative communication process between a leaf ECU 116 and a gateway ECU 110 over a OVN Bus 114, illustrating the signaling involved in the authentication and data exchange process. The figure highlights the sequence of messages exchanged between the two ECUs, emphasizing the role of authentication in ensuring secure communication within the on-vehicle network.

Initially, the process begins, in step 500, with a wakeup and address claim signal, which is necessary for establishing communication between the leaf ECU 116 and the gateway ECU 110. This step ensures that the ECUs are ready to communicate and have established their respective addresses on the network.

Following the wakeup and address claim, in step 502, the leaf ECU 116 sends an OVN message containing a 64-bit hash to the gateway ECU 110. This message is part of the authentication process, where the hash is generated using a cryptographic algorithm based on a skipping counter and a key. The gateway ECU 110 verifies the received hash to authenticate the leaf ECU 116, ensuring that only authorized ECUs can access the network. The authentication message in step 502 may be considered as being only for the leaf ECU 116 to authenticate.

Once authentication is successful, the leaf ECU 116 can send and receive non-authentication OVN messages over the OVN bus 114, as in steps 504, 506 and 508. These messages, labeled as OVN message 1 and OVN message 2, represent the regular data exchange between the ECUs, which can include various control and operational data necessary for the vehicle's functioning. In alternative embodiments, successful authentication of a leaf ECU may not be necessary to send and receive other OVN messages. Blocking of communication based on the authentication message may depend on the architecture and manufacturer implementation.

Periodically, the leaf ECU 116 sends another OVN message containing a 64-bit hash to the gateway ECU 110, as in step 510, which can authenticate the leaf ECU 116 thereby allowing the leaf ECU 116 to send and receive further non-authentication OVN messages over the OVN bus 114, as in step 512. This periodic authentication ensures continuous verification of the leaf ECU 116, maintaining the integrity and security of the communication within the on-vehicle network. The periodic nature of this authentication process helps prevent unauthorized access and potential security threats, such as swapping of ECU or firmware alteration. In some embodiments, the OVN bus and OVN messages are a CAN bus and CAN messages. In other embodiments, the OVN bus and OVN messages may be other types of on-vehicle network communication systems and protocols.

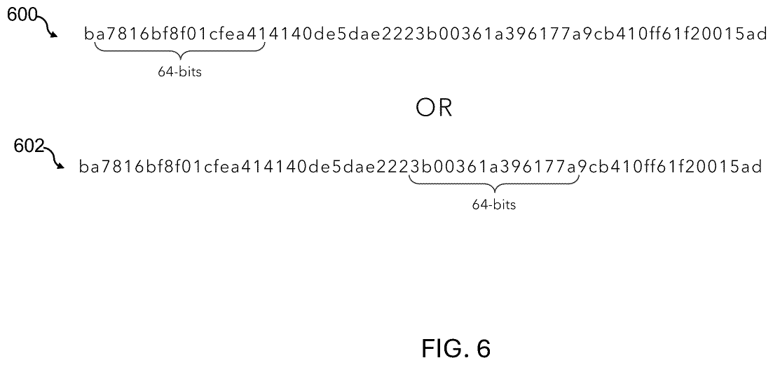

FIG. 6 shows two alternative embodiments for extracting and truncating 64 bits from a 256-bit hash. This figure illustrates the flexibility in selecting different segments of the hash for transmission over the OVN bus.

In the first embodiment 600, the 64-bit segment is extracted from the beginning of the 256-bit hash. This approach allows for a straightforward extraction process, where the initial portion of the hash is used for authentication purposes. The selection of this segment can be predetermined and agreed upon by the communicating ECUs, ensuring consistency in the authentication process.

In the second embodiment 602, the 64-bit segment is extracted from a different position within the 256-bit hash. This alternative extraction method provides additional security by introducing variability in the segment used for authentication. By selecting a different portion of the hash, the system can enhance resistance to replay attacks and other security threats, as the specific segment used for authentication is not easily predictable. In alternative embodiments, the extracted segment may be more or less than 64-bits. In alternative embodiments, the size of the hash may be more or less than 256 bits.

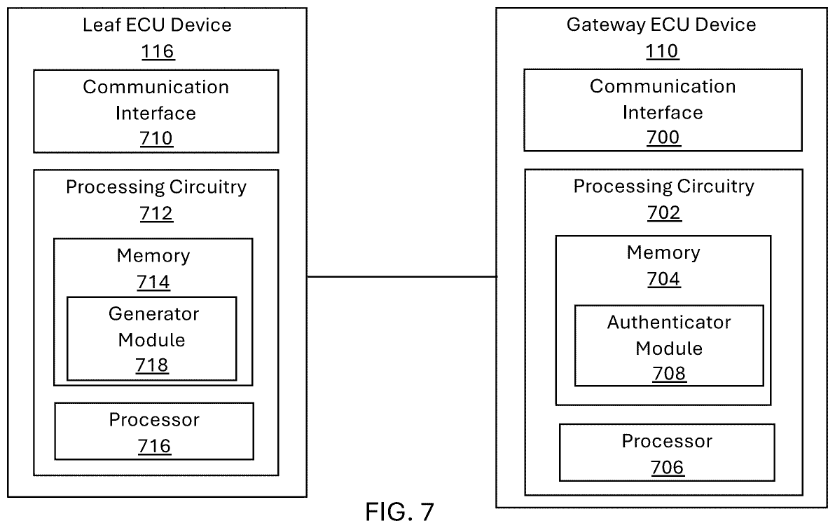

Referring to FIG. 7, one embodiment of an electronic device implemented as the gateway ECU 110 is described. The gateway ECU 110 includes a communication interface 700 and processing circuitry 702. The communication interface 700 is configured to set up and maintain a wired connection with an interface of a different communication device of the system, such as the leaf ECU 116. The communication interface 700 may include a network interface card for setting up and maintaining a wired connection to the leaf ECU 116. The processing circuitry 702 includes memory 704 and one or more processors 706. The processing circuitry 702 and/or processors 706 may be, for example, a central processing unit (CPU), field programmable gate array (FPGA), application-specific integrated circuitry (ASIC), and the like. The memory 704 may include any kind of volatile and/or nonvolatile memory, e.g., cache, buffer memory, random access memory (RAM), read-only memory (ROM), and the like. The memory 704 includes the authentication module 708 (in one embodiment, authentication module 708 includes MG and verification (V) modules 122 and 124 described above with respect to FIG. 2), which has computer instructions that, when executed by the processor 706, causes the gateway ECU 110 to perform the methods and techniques described in this disclosure.

Referring still to FIG. 7, one embodiment of an electronic device implemented as the leaf ECU 116 is described. The leaf ECU 116 includes a communication interface 710 and processing circuitry 712. The communication interface 710 is configured to set up and maintain a wired connection with an interface of a different communication device of the system, such as the gateway ECU 110. The communication interface 710 may include a network interface card for setting up and maintaining a wired connection to the gateway ECU 110. The processing circuitry 712 includes memory 714 and one or more processors 716. The processing circuitry 712 and/or processors 716 may be, for example, a central processing unit (CPU), field programmable gate array (FPGA), application-specific integrated circuitry (ASIC), and the like. The memory 714 may include any kind of volatile and/or nonvolatile memory, e.g., cache, buffer memory, random access memory (RAM), read-only memory (ROM), and the like. The memory 714 includes the generator module 718 (in one embodiment, generator module 718 includes MG module 120 described above with respect to FIG. 2), which has computer instructions that, when executed by the processor 716, causes the leaf ECU 116 to perform the methods and techniques described in this disclosure.

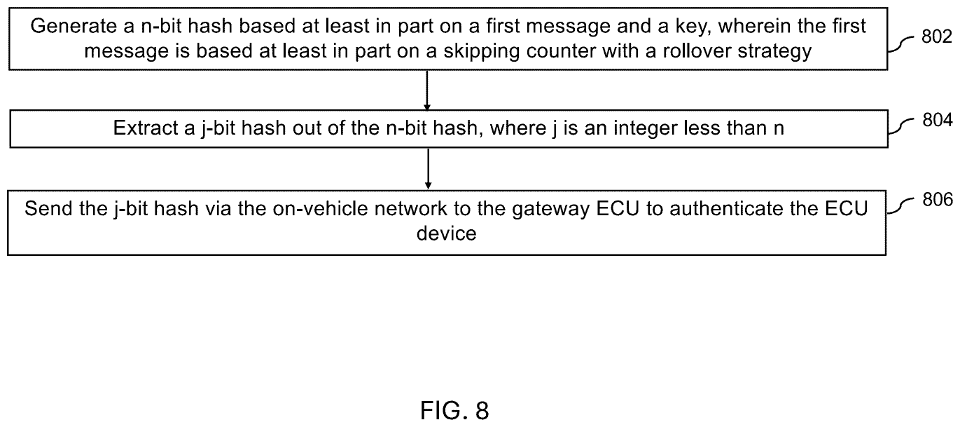

FIG. 8 illustrates a flowchart diagram of the method implemented by the leaf ECU 116 for authenticating itself to the gateway ECU 110 within a transportation vehicle network. This method is executed by one or more of the leaf ECU device 116's computer hardware components, as described with reference to FIG. 7, to ensure secure communication and prevent unauthorized access.

In step 802, the leaf ECU 116, utilizing its processor 716 and generator module 718, a) generates an n-bit hash based at least in part on a first message and a key. The first message is derived from a skipping counter with a rollover strategy, which introduces randomness and complexity to the hash generation process. This approach enhances security by making it difficult for attackers to predict or replicate the hash, thereby mitigating the risk of replay attacks.

In step 804, the leaf ECU 116 b) extracts a j-bit hash from the n-bit hash, where j is an integer less than n. This extraction process involves the processor 716 selecting a specific segment of the hash, which is predetermined and agreed upon by the leaf ECU and the gateway ECU. The extracted j-bit hash is tailored to fit the constraints of the legacy on-vehicle network (OVN) bus, allowing for efficient data transmission while maintaining the integrity and authenticity of the communication.

In step 806, the leaf ECU 116, through its communication interface 710, c) sends the j-bit hash via the on-vehicle network to the gateway ECU 110 to authenticate the ECU device. This step ensures that the leaf ECU can verify its identity to the gateway ECU, maintaining the security of the vehicle's electronic systems. The periodic nature of this authentication process helps prevent unauthorized access and potential security threats, such as spoofing and replay attacks, by ensuring continuous verification of the leaf ECU.

In some embodiments, the leaf ECU device 116 is configured to, periodically, at predetermined intervals, increment the skipping counter by i, where i is an integer greater than 1; and repeat a), b) and c) to continually authenticate the ECU device 116 to the gateway ECU 110. In some embodiments, the leaf ECU device 116 is configured to, if the skipping counter has reached a reset value associated with the rollover strategy: split i into a first value corresponding to a maximum limit of the skipping counter and a remainder value; and roll over the skipping counter to restart at the remainder value. In some embodiments, j is an integer based on a legacy on-vehicle network (OVN) bus size and wherein a hash function used to generate the n-bit hash is based on a legacy ECU random access memory (RAM) size. In some embodiments, the leaf ECU device 116 is configured to truncate a plurality of bits of the n-bit hash, wherein a number and a location of the plurality of bits to be truncated are predetermined by the ECU gateway 110 and the ECU device 116 and not communicated via the on-board network. In some embodiments, the gateway ECU device 110 is connected to an external network outside the vehicle and a failure of any ECU device connected to the on-board network to authenticate is communicated to the external network. In some embodiments, the leaf ECU device 116 is configured to use a plurality of different hash functions with the first message and the key as inputs.

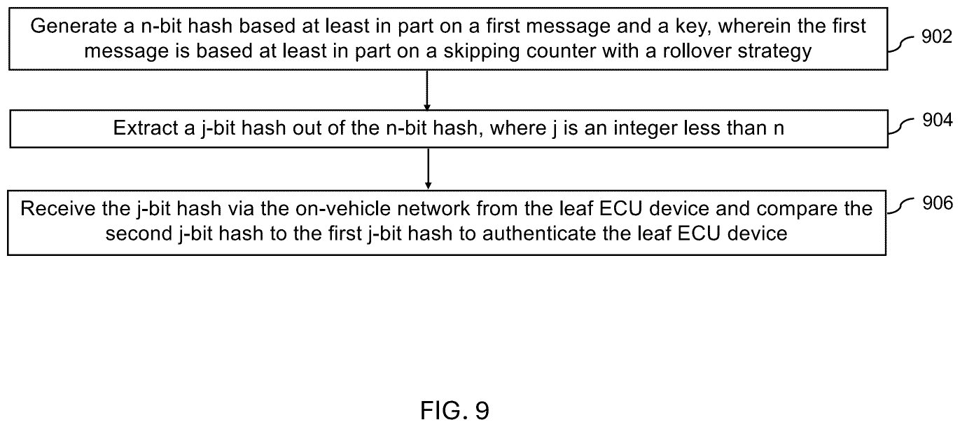

FIG. 9 shows a method implemented by a gateway electronic control unit (ECU) for authenticating a leaf ECU device within a transportation vehicle network. This method is executed by the gateway ECU to ensure secure communication and prevent unauthorized access.

In step 902, the gateway ECU generates an n-bit hash based at least in part on a first message and a cryptographic element. The first message is derived from a skipping counter with a rollover strategy, which introduces randomness and complexity to the hash generation process. This approach enhances security by making it difficult for attackers to predict or replicate the hash, thereby mitigating the risk of replay attacks.

In step 904, the gateway ECU extracts a j-bit hash from the n-bit hash, where j is an integer less than n. This extraction process involves selecting a specific segment of the hash, which is predetermined and agreed upon by the gateway ECU and the leaf ECU device. The extracted j-bit hash is tailored to fit the constraints of the legacy on-vehicle network (OVN) bus, allowing for efficient data transmission while maintaining the integrity and authenticity of the communication. The term “extract” is used in a broad sense herein to refer to the computing process of retrieving, isolating, or deriving specific data from a larger dataset, structure, or file and may include selecting relevant portions, truncating irrelevant portions and/or reformatting or restructuring in order to derive the specific data.

In step 906, the gateway ECU receives the j-bit hash via the on-vehicle network from the leaf ECU device and compares the second j-bit hash to the first j-bit hash to authenticate the leaf ECU device. This step ensures that the leaf ECU can verify identity to the gateway ECU, maintaining the security of the vehicle's electronic systems. The periodic nature of this authentication process helps prevent unauthorized access and potential security threats, such as spoofing and replay attacks, by ensuring continuous verification of the leaf ECU.

In some embodiments, the gateway ECU 110 is configured to, periodically, at predetermined intervals: increment the skipping counter by i, where i is an integer greater than 1; and repeat a), b) and c) to continually authenticate the leaf ECU device 116. In some embodiments, the gateway ECU 110 is configured to, if the skipping counter has reached a reset value associated with the rollover strategy: split i into a first value corresponding to a maximum limit of the skipping counter and a remainder value; and roll over the skipping counter to restart at the remainder value. In some embodiments, j is an integer based on a legacy on-vehicle network (OVN) bus size and wherein a hash function used to generate the n-bit hash is based on a legacy ECU random access memory (RAM) size. In some embodiments, the gateway ECU 110 is configured to extract the j-bit hash out of the n-bit hash by being configured to truncate a plurality of bits of the n-bit hash, wherein a number and a location of the plurality of bits to be truncated are predetermined by the ECU device and the leaf ECU device and not communicated via the on-board network. In some embodiments, the gateway ECU 110 is connected to an external network outside the vehicle and a failure of any leaf ECU devices connected to the on-board network to authenticate is communicated by the ECU device to the external network. In some embodiments, the gateway ECU 110 is configured to generate the n-bit hash by being configured to use a plurality of different hash functions with the first message and the key as inputs.

While the disclosure and what is presently considered to be the best mode thereof has been described in a manner establishing possession and enabling those of ordinary skill in the art to make and use the same, it will be understood and appreciated that there are many equivalents to the select embodiments described herein and that myriad modifications and variations may be made thereto without departing from the scope and spirit of the disclosure, which is to be limited not by the embodiments described herein but by the appended claims and their equivalents. For example, various components of the embodiments may be interchanged, added, or substituted in the other embodiments.

What is claimed is:

1. An electronic control unit (ECU) device connected to an on-vehicle network inside a vehicle, the ECU device comprising:
a communication interface configured to communicate via the on-vehicle network to a gateway ECU to authenticate the ECU device;
at least one processor; and
a memory storing at least one computer instruction executable by the at least one processor to:
a) generate a n-bit hash based at least in part on a first message and a key, wherein the first message is based at least in part on a skipping counter with a rollover strategy;
b) extract a j-bit hash out of the n-bit hash, where j is an integer less than n; and
c) cause the communication interface to send the j-bit hash via the on-vehicle network to the gateway ECU to authenticate the ECU device.

2. The ECU device of claim 1, wherein the at least one processor is configured to, periodically, at predetermined intervals:
increment the skipping counter by i, where i is an integer greater than 1; and
repeat a), b) and c) to continually authenticate the ECU device to the gateway ECU.

3. The ECU device of claim 2, wherein the at least one processor is configured to, if the skipping counter has reached a reset value associated with the rollover strategy:
split i into a first value corresponding to a maximum limit of the skipping counter and a remainder value; and
roll over the skipping counter to restart at the remainder value.

4. The ECU device of claim 1, wherein j is an integer based on a legacy on-vehicle network (OVN) bus size and wherein a hash function used to generate the n-bit hash is based on a legacy ECU random access memory (RAM) size.

5. The ECU device of claim 1, wherein the at least one processor is configured to extract the j-bit hash out of the n-bit hash by being configured to:
truncate a plurality of bits of the n-bit hash, wherein a number and a location of the plurality of bits to be truncated are predetermined by the ECU gateway and the ECU device and not communicated via the on-board network.

6. The ECU device of claim 1, wherein the gateway ECU device is connected to an external network outside the vehicle and a failure of any ECU device connected to the on-board network to authenticate is communicated to the external network.

7. The ECU device of claim 1, wherein the at least one processor is configured to generate the n-bit hash by being configured to:
use a plurality of different hash functions with the first message and the key as inputs.

8. An electronic control unit (ECU) device connected to an on-vehicle network inside a vehicle, the ECU device comprising:
a communication interface configured to communicate via the on-vehicle network to a leaf ECU device to authenticate the leaf ECU device;
at least one processor; and
a memory storing at least one computer instruction executable by the at least one processor to:
a) generate a n-bit hash based at least in part on a first message and a key, wherein the first message is based at least in part on a skipping counter with a rollover strategy;
b) extract a first j-bit hash out of the n-bit hash, where j is an integer less than n;
c) cause the communication interface to receive a second j-bit hash via the on-vehicle network from the leaf ECU device and compare the second j-bit hash to the first j-bit hash to authenticate the leaf ECU device.

9. The ECU device of claim 8, wherein the at least one processor is configured to, periodically, at predetermined intervals:
increment the skipping counter by i, where i is an integer greater than 1; and
repeat a), b) and c) to continually authenticate the leaf ECU device.

10. The ECU device of claim 9, wherein the at least one processor is configured to, if the skipping counter has reached a reset value associated with the rollover strategy:
split i into a first value corresponding to a maximum limit of the skipping counter and a remainder value; and
roll over the skipping counter to restart at the remainder value.

11. The ECU device of claim 8, wherein j is an integer based on a legacy on-vehicle network (OVN) bus size and wherein a hash function used to generate the n-bit hash is based on a legacy ECU random access memory (RAM) size.

12. The ECU device of claim 8, wherein the at least one processor is configured to extract the j-bit hash out of the n-bit hash by being configured to:
truncate a plurality of bits of the n-bit hash, wherein a number and a location of the plurality of bits to be truncated are predetermined by the ECU device and the leaf ECU device and not communicated via the on-board network.

13. The ECU device of claim 8, wherein the ECU device is connected to an external network outside the vehicle and a failure of any leaf ECU devices connected to the on-board network to authenticate is communicated by the ECU device to the external network.

14. The ECU device of claim 8, wherein the at least one processor is configured to generate the n-bit hash by being configured to:
use a plurality of different hash functions with the first message and the key as inputs.

15. A method implemented by an electronic control unit (ECU) device connected to an on-vehicle network inside a vehicle, the method comprising:
a communication interface configured to communicate via the on-vehicle network to a gateway ECU to authenticate the ECU device;
at least one processor; and
a memory storing at least one computer instruction executable by the at least one processor to:
a) generate a n-bit hash based at least in part on a first message and a key, wherein the first message is based at least in part on a skipping counter with a rollover strategy;
b) extract a j-bit hash out of the n-bit hash, where j is an integer less than n; and
c) cause the communication interface to send the j-bit hash via the on-vehicle network to the gateway ECU to authenticate the ECU device.

16. The method of claim 15, further comprising, periodically, at predetermined intervals:
incrementing the skipping counter by i, where i is an integer greater than 1; and
repeating a), b) and c) to continually authenticate the ECU device to the gateway ECU.

17. The method of claim 16, further comprising, if the skipping counter has reached a reset value associated with the rollover strategy:
splitting i into a first value corresponding to a maximum limit of the skipping counter and a remainder value; and
rolling over the skipping counter to restart at the remainder value.

18. The method of claim 15, wherein j is an integer based on a legacy on-vehicle network (OVN) bus size and wherein a hash function used to generate the n-bit hash is based on a legacy ECU random access memory (RAM) size.

19. The method of claim 15, wherein the extracting the j-bit hash out of the n-bit hash comprises:
truncating a plurality of bits of the n-bit hash, wherein a number and a location of the plurality of bits to be truncated are predetermined by the ECU gateway and the ECU device and not communicated via the on-board network.

20. The method of claim 15, wherein the generating the n-bit hash comprises:
using a plurality of different hash functions with the first message and the key as inputs.
